(19) United States
(12) Patent Application Publication
(10) Pub. No.: US 2020/0376699 A1
(43) Pub. Date: Dec. 3, 2020

(54) HEATED BLADES MODULAR INSERT FOR A BLADE CARTRIDGE HOUSING OF A RAZOR

(71) Applicant: Louis D. Tomassetti, Pompano Beach, FL (US)

(72) Inventor: Louis D. Tomassetti, Pompano Beach, FL (US)

(21) Appl. No.: 16/888,243

(22) Filed: May 29, 2020

Related U.S. Application Data
(60) Provisional application No. 62/854,698, filed on May 30, 2019.

(51) Int. Cl. B26B 21/48; B26B 21/40

(52) U.S. Cl. CPC B26B 21/48; B26B 21/4012; B26B 21/405

(57) ABSTRACT

A modular blade cartridge insert is structured for receipt within a previously molded and designed plastic frame of a conventional multiblade razor cartridge. The modular insert includes a cage having an arrangement of blades positioned in parallel arrangement and electrically connected in series by bridge contacts between alternating adjacent pairs of blades. The modular insert further includes an anode and catode connector for electrical connection to an electrical circuit including a power source and a switch, wherein electric current flows to the anode and through the blades and then back through the catode in the electrical circuit, upon operation of the switch to an on position to close the circuit. In a further embodiment, the multiple blades in the cage of the modular insert are heated by RF energy.

This non-provisional patent application is based on provisional patent application Ser. No. 62/854,698 filed on May 30, 2019.

### BACKGROUND OF THE INVENTION

### Field of the Invention

The present invention relates to razors for shaving and, more particularly, to razors that have multiple blades that are heated within a blade cartridge.

### Discussion of the Related Art

It is well-known that hairs are softened and easier to cut when they are heated just prior to being cut by the sharp cutting edge of a razor blade(s). It is also well-known that the cutting edge of the razor blade(s) is more effective in cutting hairs when the blade(s) is warm or hot. Just prior to shaving, most people warm the hairs and the skin with hot water or a hot towel. It is also common practice to place the razor under hot running water in order to heat the blades just prior to stroking the blades over the skin in order to cut the hairs. However, the heat cutting performance of the blades lasts only a short time during the beginning of the shaving stroke process. Within seconds, the temperature of the skin surface, hairs and the blade are quickly reduced due to exposure to the ambient air temperature. Ideally, it is best to maintain the blades warm or hot throughout the shaving process.

In order to provide a solution to maintain the blades warm or hot throughout the shaving process, I, along with other co-inventors, have previously invented various razors with blade heating systems, as disclosed in the following U.S. patents and Published patent applications: U.S. Pat. Nos. 9,604,375; 9,498,891; 9,440,366; 9,399,304; 9,149,945; 8,776,378; 8,713,801; 8,533,958; 6,817,101; U.S. Published Patent Application Nos. 2018/0126572 and 2020/0016781, and the contents of all of the above patents and patent applications are incorporated herein by reference.

Our prior inventions for razors with heated blades, as disclosed in the above referenced U.S. patents and published U.S. patent applications heat the blades either by directing electric current through the blades or by RF energy wherein RF energy is radiated from a resonance chamber towards the one or more blades in the blade cartridge which absorb the RF energy, thereby causing the temperature of the blades to increase.

In each of our prior inventions for various razors having heated blades systems, there is a need for special manufacturing of the blade cartridge. More specifically, the entire blade cartridge, including the plastic frame component and the metal blades, needs to be specially designed and molded as a completely new blade cartridge product. This involves some expense in the design and molding process of the plastic frame structure of the blade cartridge. The present invention seeks to eliminate the need for a manufacturer to design a completely new blade cartridge frame and allows a razor manufacturer to user their existing blade cartridge frame, thereby significantly reducing the design and production costs.

### SUMMARY OF THE INVENTION

The present invention is directed to a modular blade cartridge insert structured for receipt within a previously molded and designed plastic frame of a conventional multiblade razor cartridge. The modular insert includes a cage having an arrangement of blades positioned in parallel arrangement and electrically connected in series by bridge contacts between alternating adjacent pairs of blades. The modular insert further includes an anode and catode connector for electrical connection to an electrical circuit including a power source (e.g., one or more batteries) and a switch, wherein electric current flows to the anode and through the blades and then back through the catode in the electrical circuit, upon operation of the switch to an on position to close the circuit. In a further embodiment, the multiple blades in the cage of the modular insert are heated by RF energy.

### BRIEF DESCRIPTION OF THE DRAWINGS

For a fuller understanding of the nature of the present invention, reference should be made to the following detailed description taken in conjunction with the accompanying drawings in which:

FIG. 1 is a front perspective view of the heated blades cage modular insert of the present invention;

FIG. 2 is a rear perspective view of the heated blades cage modular insert indicating a direction of current flow through the blades in the blades cage modular insert;

FIG. 2A is an isolated perspective view taken from FIG. 2 showing bridge contacts between adjacent blades and an insulated blade connector with insulated spacers between alternating adjacent pairs of blades, to thereby electrically connect the blades in series to achieve the current flow as indicated in FIG. 2;

FIG. 3 is a front perspective view of a cartridge frame in the prior art which has been slightly modified to accept the heated blades cage modular insert of the present invention;

FIG. 4 is a front perspective view showing the heated blades cage of the present invention inserted into the prior art cartridge frame of FIG. 3; and

FIG. 5 is a front perspective view showing the completed assembly of the heated blades cage inserted within the prior art cartridge frame with insulated staples attached to secure the heated blades cage within the cartridge frame.

Like reference numerals refer to like parts throughout the several views of the drawings.

### DETAILED DESCRIPTION OF THE PREFERRED EMBODIMENTS

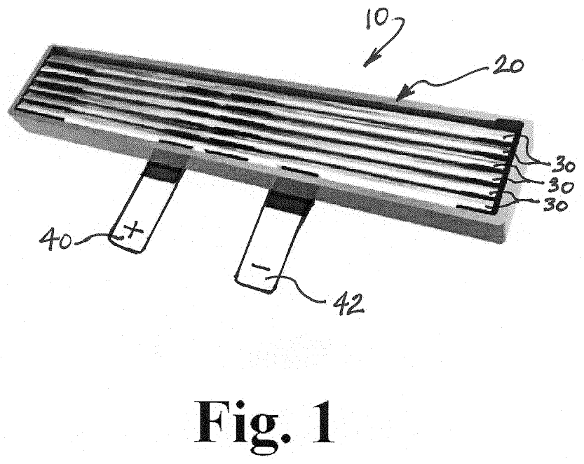

Referring initially to FIG. 1, the heated blades cage modular insert of the present invention is shown and is generally indicated as 10 throughout the drawings. The heated blades cage modular insert 10 includes an outer frame structure, an arrangement of blades within the frame structure 20 and anode 40 and catode 42 connections for electrically connecting the blades 30 to an electric circuit having a power source (e.g., one or more batteries) and a switch for opening and closing the electric circuit.

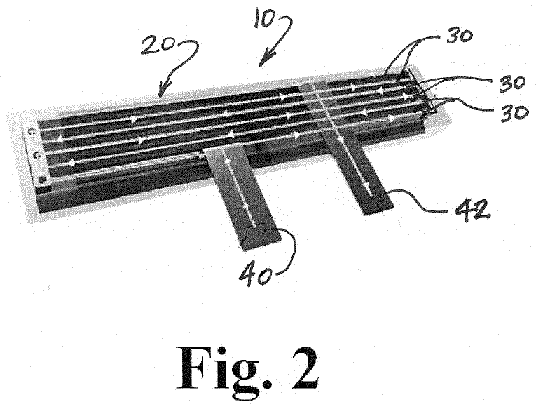

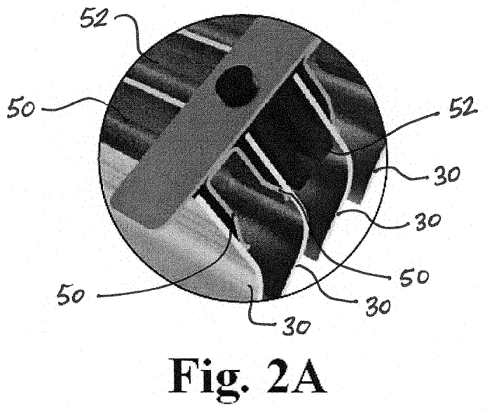

Referring to FIG. 2, a rear perspective view of the heated blades cage modular insert 10 is shown. In particular, the direction of current flow through the blades 30, from the anode 40, along the length of each of the blades 30 and to the catode 42 is shown. This particular connection and arrangement of the blades 30 allows for electrical connection of the blades 30 in series. Referring to FIG. 2A, a connector at opposite ends of the blades includes bridge contacts 50 between alternating adjacent pairs of blades 30 to electrically connect the adjacent pairs of blades in series. Between the next arranged pair of blades 30, in alternating sequence, the connector device includes an insulated spacer 52 between the blades, as shown in FIG. 2A. This allows for electrical connection of the blades in series to achieve the current flow as shown in FIG. 2.

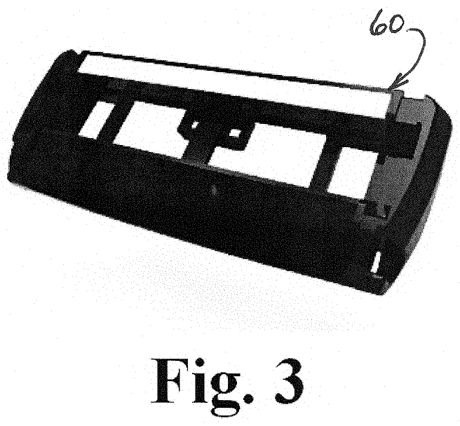

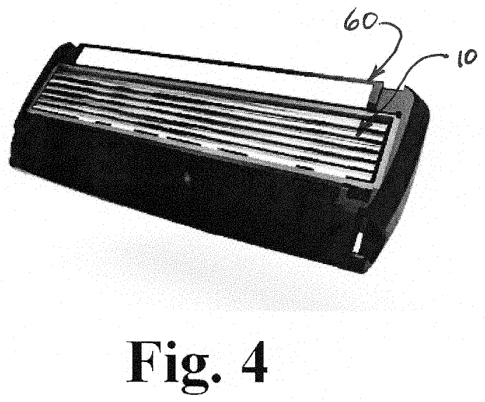

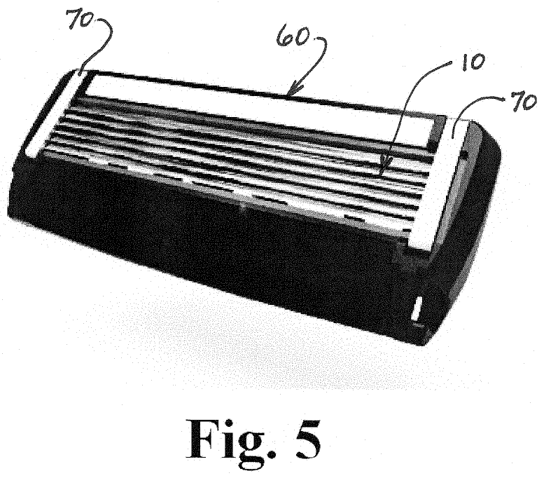

Referring to FIG. 3, a typical molded plastic blade cartridge frame 60 in the prior art is shown. The illustrated plastic cartridge frame 60 has been slightly modified to accept the heated blades cage modular insert 10 of the present invention. FIG. 4 illustrates the heated blades cage modular insert 10 received within the plastic cartridge frame 60 of FIG. 3. The final assembly includes attachment of insulated staples 70, as shown in FIG. 5, to secure the heated blades cage modular insert 10 within the cartridge frame 60.

The heated blades cage modular insert 10 of the present invention allows for a razor manufacturer to use their existing cartridge frame 60 without having to completely modify the cartridge frame 60 to accept heated blades. Therefor, the existing molds for a razor company's existing cartridge frames can still be used, with slight modifications to allow for the space to accept the heated blades cage modular insert of the present invention. The assembly of the heated blades cage modular insert 10 within the plastic cartridge frame 60 is simple, as demonstrated in FIGS. 3-5.

In a further embodiment of the invention, the blades 30 in the heated blades cage modular insert 10 are heated by RF energy, wherein RF energy is radiated from a resonance chamber in the handle of the razor towards the blades 30 which absorb the RF energy, thereby causing the temperature of the blades to increase. The RF energy is generated and radiated in the manner as described in our prior published patent application nos. US 2018/0126572 and US 2020/0016781 the contents of which are incorporated herein by reference.

While the present invention has been shown in accordance with several preferred and practical embodiments, it is recognized that departures from the instant disclosure are fully contemplated within the spirit and scope of the present invention which is not to be limited except as defined in the following claims as interpreted under the Doctrine of Equivalents.

What is claimed is:

1. A modular blade cartridge insert for receipt within a plastic molded cartridge frame for a razor, the modular blade cartridge insert comprising:
a cage having a frame structure, and the frame structure being sized, structured and configured for receipt within the plastic molded cartridge frame;
a plurality of metal blades held within the cage in a fixed arrangement so that the plurality of blades extend in parallel, spaced relation to one another; and
wherein the blades are structured to be heated by a heat generating source.

2. The modular blade cartridge insert as recited in claim 1 wherein the plurality of blades are electrically connected to one another in series, and wherein the plurality of blades are structured for receiving an electric current therethrough to cause the blades to be heated.

3. The modular blade cartridge insert as recited in claim 2 wherein the plurality of blades are electrically connected in series using bridge contacts between alternating adjacent pairs of blades in the cage.

4. The modular blade cartridge insert as recited in claim 3 further comprising:
an anode connector and a catode connector each electrically connected to the plurality of blades and the anode connector and catode connector being structured for connection to an electrical circuit for receiving an electric current flow to the anode and through the plurality of blades and then back through the catode in the electrical circuit, to thereby cause the blades to be heated as a result of an electrical resistance of the material of the plurality of blades.

5. The modular blade cartridge insert as recited in claim 1 wherein the plurality of blades are heated by RF energy.

6. A modular blade cartridge insert for receipt within a plastic molded cartridge frame for a razor, the modular blade cartridge insert comprising:
a cage having a frame structure, and the frame structure being sized, structured and configured for receipt within the plastic molded cartridge frame;
a plurality of metal blades held within the cage in a fixed arrangement so that the plurality of blades extend in parallel, spaced relation to one another;
the plurality of blades are electrically connected to one another in series, and the plurality of blades are structured for receiving an electric current therethrough; and
an anode connector and a catode connector each electrically connected to the plurality of blades and the anode connector and the catode connector being structured for connection to an electrical circuit for receiving an electric current flow to the anode and through the plurality of blades and then back through the catode in the electrical circuit, to thereby cause the blades to be heated as a result of an electrical resistance of the material of the plurality of blades.

7. The modular blade cartridge insert as recited in claim 6 wherein the plurality of blades are electrically connected in series using bridge contacts between alternating adjacent pairs of blades in the cage.
